(19) United States
(12) Patent Application Publication
(10) Pub. No.: US 2004/0230502 A1
(43) Pub. Date: Nov. 18, 2004

(54) System and method for distributing healthcare products

(76) Inventors: John Fiacco, Powell, OH (US); Tina Gail Eichler, Galena, OH (US); Troy Lynn Hanson, Columbus, OH (US)

Correspondence Address: Michael D. Steffensmeier, Cardinal Health, Inc., 7000 Cardinal Place, Dublin, OH, 43017, US

(21) Appl. No.: 10/438,703

(22) Filed: May 13, 2003

(51) Int. Cl. G06F 17/60

(52) U.S. Cl. 705/28

(57) ABSTRACT

A system and method for distributing healthcare products is disclosed. A patient who obtains a prescription from clinic such as a federally qualified 340B health clinic (FQHC) is entered into a retail pharmacy's computer as a third party patient. Prescription information is transmitted to a healthcare product distributor inventory tracking system where the retail pharmacy is credited at its original invoice cost for the product. The healthcare product distributor's system charges the FQHC for the product at the 340B price. The inventory system tracks each 340B product distributed. In some cases, the first time a product is dispensed, the FQHC is charged for a stock package size and subsequent prescriptions are tracked and applied against the original purchase until the amount dispensed equals or exceeds the stock package originally charged to the FQHC. Once the quantity dispensed exceeds the stock package size, the inventory accumulation process is restarted.

### FIELD OF THE INVENTION

The present invention relates to systems and methods for distributing healthcare products. In particular, the present invention relates to a system and method for distributing 340B healthcare products and managing a related pharmaceutical inventory. BACKGROUND OF THE INVENTION

Section 340B of the Public Health Service (PHS) Act is the specific area of public health law that addresses indigent care. The 340B program was created by the Federal government to make low cost medication and healthcare supplies available to the indigent population of the United States (“340B Program”). The 340B program derives its authority from Section 602 of the Veterans Health Care Act of 1992, which enacted Section 340B of the PHS Act. Section 340B authorizes certain safety net organizations, called “covered entities,” to purchase medications and healthcare supplies at prices not to exceed a statutorily set ceiling price.

Ceiling price discounts average 25 percent to 40 percent on most drugs and supplies. The heart of the program, therefore, is the low cost medication and healthcare supplies made available by the pharmaceutical and medical supply manufacturing community and distributed to patients through a pricing portfolio that is significantly below wholesale acquisition cost.

The Health Resources Service Administration (“HRSA”), a division of Health and Human Services (“HHS”) administers the program for HHS. HRSA has made provisions for federally qualified 340B health clinics (“FQHCs”) to contract with retail pharmacies to provide medications and medical supplies for their patients. Under the current system, a FQHC orders the medication or healthcare product and delivers it or has it delivered to the retail pharmacy to take advantage of the 340B pricing. The system is not efficient and causes additional work for the FQHC and the retail pharmacy. The inventory, once delivered to the retail pharmacy is preferably segregated from regular pharmacy stock and used only for patients of the FQHC. In the current system, the retail pharmacy must track inventory and notify the FQHC when stock must be replenished. The FQHC then orders the medication or healthcare products and the process is repeated. Not only is this process burdensome for both parties, but the very nature of segregated inventory lends itself to diversion of the 340B inventory stock. It is likely that 340B inventory and regular inventory will be mixed during the normal course of business. Illegal diversion of the 340B products may occur thereby reducing the integrity of the program. Because the current system is difficult to implement and manage, many retail pharmacies have chosen not to participate in the program or to charge the clinic/patient more than 340B prices. In addition, many FQHCs do not take advantage of the 340B prices, choosing to pay the higher average wholesale price or average wholesale price less a modest discount. Because the current process is cumbersome, the 340B Program remains under-utilized. Therefore, there is a need for a system and method distributing 340B healthcare products and managing a related 340B healthcare product and pharmaceutical inventory. SUMMARY OF THE INVENTION

The present invention-the 340B Virtual Inventory Program-provides seamless ordering and accounting processes for the FQHC and for the retail pharmacy. It streamlines ordering and receiving, eliminates the necessity of segregated stock, and improves accountability for all parties involved. The simplified system encourages greater participation of retail pharmacies. More providers in the system translate into expanded use of the 340B Program by FQHCs. More people benefit from this program, helping to improve the health and welfare of the indigent population, which is the intention of the 340B Program. Improving access to medication and medical supplies for the indigent will help to reduce the cost of healthcare, and exposing the indigent to disease state management and medication monitoring by community pharmacists will help to improve overall health and reduce clinic/physician visits, ultimately helping to reduce hospitalization costs.

In the 340B Virtual Inventory Program of the present invention, the 340B patient is treated as a third party patient (i.e., a patient whose prescription is covered by a third party payer). As further described below, the patient is entered into the retail pharmacy's computer as a third party patient and prescription data related to the item prescribed to the patient is entered into the retail pharmacy's computer. The prescription data may be captured by a switch that sends a prescription claim data packet to a healthcare product distributor inventory tracking system. A designated prescription benefits manager may be used to verify eligibility of the patient. The healthcare product distributor inventory tracking system processes the prescription claim data and captures information related to the claim. The retail pharmacy, as a customer of the healthcare product distributor, is credited at its current contract price for the medication or supplies dispensed to the 340B patient or it receives a product replacement. The healthcare product distributor's inventory tracking system charges the FQHC for the medication or supplies at the applicable 340B price. The healthcare product distributor's inventory tracking system tracks each healthcare product dispensed and charged to the FQHC, and in some cases, it accumulates inventory relative to each 340B item. In one embodiment of the invention, the first time a prescription for a specific medication, supply, or healthcare product is dispensed, the FQHC is charged for a stock (i.e., full) package size. Subsequent prescriptions for that medication or supply are tracked in the healthcare product distributor inventory tracking system and are applied against the original stock package purchase until the amount dispensed equals or exceeds the stock package originally charged to the FQHC. Once the quantity dispensed exceeds the stock package size, a new purchase event is created, restarting the inventory accumulation process. Alternatively, the FQHC may be charged for only the item dispensed while the pharmacy is credited for the item dispensed (either by an actual credit or replacement product). Charges to the FQHC are accumulated for billing and invoicing purposes.

The process of the present invention eliminates the need for 340B inventory ordering by either the FQHC or the retail pharmacy. It also eliminates the necessity and resulting work associated with a segregated inventory, and the possibility of diversion is nearly eliminated. Further, the healthcare product distributor can provide complete records related to each medication or product dispensed through the 340B Program.

The unique and innovative approach to the charging and billing of 340B inventories in a retail pharmacy results in many benefits. The 340B Virtual Inventory Program of the present invention helps to expand the use of the 340B Program making low cost medication available to more people, thereby helping to improve their health and drive down the cost of health care.

The 340B Virtual Inventory Program system and method of the present invention eliminates much of the work associated with conventional handling of 340B prescriptions and inventory. 340B prescriptions are handled as another third party prescription. The prescription data is entered into the retail pharmacy computer system and filled like all other prescriptions.

Information on the inventory dispensed from the retail pharmacy is sent as prescription claim data to a healthcare product distributor inventory tracking system where it is captured. The healthcare product distributor inventory tracking system also provides both the retail pharmacy and the 340B entity with a full range of reports on inventory activity and tracking. These reports are available to all applicable government agencies auditing the 340B program. Streamlining the prescription filling, distributing, and inventory processes for 340B will expand participation in the 340B program by enabling more pharmacies to participate as contract pharmacies. It also reduces costs to the 340B entity. Lower cost and expanded access results in better medical care for the indigent and serves to lower health care costs for the indigent. By the virtual nature of the inventory, the possibility of diversion of 340B inventory is also significantly reduced, if not eliminated.

### BRIEF DESCRIPTION OF THE DRAWINGS

FIG. 1 is a block diagram of the primary components for an example embodiment of the present invention; and

FIG. 2 is a block diagram of the primary components for an example embodiment of the present invention which also depicts details of a healthcare product distributor inventory tracking system.

### DESCRIPTION OF EXAMPLE EMBODIMENTS

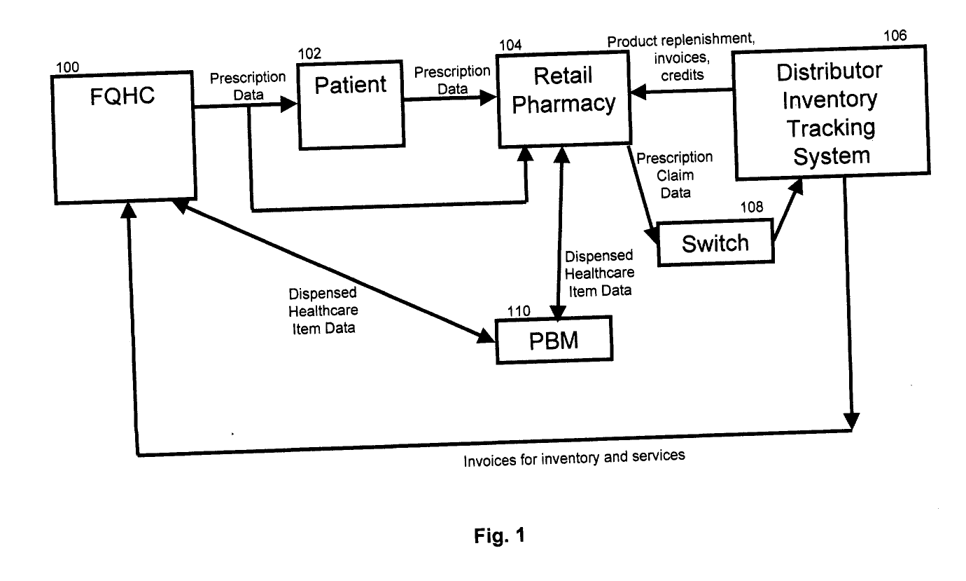

Referring to FIG. 1, a block diagram of the primary components for an example embodiment of the present invention is shown. In connection with the primary components for an example embodiment of the present invention, a description of the information flow for an example embodiment of the present invention is described. The patient visits the FQHC 100 and, after examination or consultation with a healthcare professional at the FQHC 100, the patient 102 is issued a prescription. The prescription may be for any type of healthcare item such as a pharmaceutical, medication, medicine, drug, etc., any type of medical or surgical supply, or any healthcare product subject to the 340B program. The prescription may be written and handed to the patient 102 or phoned, faxed, or electronically transmitted directly to the designated retail pharmacy 104. The patient 102 is directed to the designated retail pharmacy 104 as it is the pharmacy that can fill the prescription at the agreed on price. The patient 102 presents the prescription to the retail pharmacy 104 (if it has not been transmitted by the prescriber clinic 100) and pays any designated co-pay. The FQHC 100 may wish to collect a co-payment at this point.

Next, the retail pharmacy 104 receives the prescription by means of one of two designated channels or protocol. The retail pharmacy 104 recognizes the patient 102 as a patient of the FQHC 100 using an agreed on protocol and treats the prescription as a third party prescription.

Protocol Choice 1

The retail pharmacy 104 and the FQHC 100 create a system to manage patient identification and eligibility. This system may be as simple as a phone call to the retail pharmacy 104 by the FQHC 100 notifying it of patient eligibility to a system that graphically identifies a written prescription as 340B-eligible. In this protocol, the retail pharmacy 104 and the FQHC 100 agree on how the patients are identified and create a unique individual patient identifier (patient ID#).

Protocol Choice 2

The FQHC 100 or retail pharmacy 104 engages a third party such as a pharmacy benefits manager (“PBM”) 110 to manage patient eligibility. The PBM 110 manages patient eligibility for the FQHC 100 or retail pharmacy 104 and functions as a clearinghouse for the charging and billing process. Dispensed item information derived from the prescription data is directed electronically from the FQHC 100 or retail pharmacy 104 to the PBM 110. The PBM 110 verifies patient eligibility. The prescription is filled by the retail pharmacy 104 and required prescription claim data is transferred to a switch 108 that directs the prescription claim data to a healthcare product distributor inventory tracking system 106 for charging and billing purposes. The prescription claim data provided to the healthcare product distributor inventory tracking system 106 by the switch 108 includes the minimum amount of information necessary to create the charge. Such information may include an account number (identifying the FQHC 100), a description of the prescribed healthcare item, a transaction number, a date of service, a National Drug Code (NDC) number, a quantity, and a provider number.

The protocol, once established, is followed by the retail pharmacy 104, and the patient is entered into retail pharmacy's computer system 104 as a third party patient. Prescription data comprising patient information, a date of service, a prescribing clinician, a description of the healthcare item, and a quantity is also entered into the retail pharmacy's computer system 104. The retail pharmacy 104 adjudicates the prescription or sends it for claims capture using its normal third party billing systems and processes. Prescription claim data is then forwarded into the healthcare product distributor's inventory tracking system (“ITS”) 106. The ITS 106 manages the inventory related to the prescription claim data for the billing system.

Using conventional third party protocols and processes, the prescription claim data needed to drive the 340B Virtual Inventory Program system is received by the healthcare product distributor ITS 106. This prescription claim data may include an account number (FQHC), a transaction number, a description of the healthcare item, a date of service, a NDC number, a quantity, and a provider number (retail pharmacy). Billing and reporting is generated by this data.

When the ITS 106 receives the prescription claim data from the retail pharmacy 104, it recognizes the information as related to the 340B Program. First, it recognizes the provider (retail pharmacy 104). It then credits the retail pharmacy 104 in one of two ways based on the healthcare product distributor's vendor status with the retail pharmacy—primary or secondary. The healthcare product distributor is considered a “primary vendor” if all of the retail pharmacy's pharmaceutical and medical supply inventory has been purchased from the healthcare product distributor. The healthcare product distributor is considered a “secondary vendor” if only a portion of the retail pharmacy's pharmaceutical and medical supply inventory has been purchased from the healthcare product distributor.

Method 1. The Healthcare Product Distributor as Primary Vendor

The retail pharmacy 104 where the healthcare product distributor is the primary vendor receives a credit for the inventory dispensed on behalf of the FQHC 100 at its actual acquisition cost (“AAC”). The medication or healthcare product is credited in partial amounts and reflects all credits and rebates associated with the purchase of that particular product. Crediting the retail pharmacy 104 for the product at AAC prevents the creation of two chargeback events for the same sale.

Method 2. The Healthcare Product Distributor as Secondary Vendor

The retail pharmacy 104 where the healthcare product distributor is a secondary vendor is reimbursed for inventory dispensed on behalf of the FQHC 100 using an inventory replacement method. Because it is difficult to determine the AAC for these customers, they receive replacement product as compensation for inventory dispensed on behalf of the FQHC 100. As the ITS 106 receives the prescription claim data and recognizes it as 340B inventory for a FQHC 100, the applicable FQHC 100 is charged for the product at the applicable 340B price, thus creating a purchase event. The healthcare product distributor's inventory tracking system 106 tracks each medication or healthcare product dispensed and charged to the FQHC 100 and accumulates inventory relative to each 340B item. In one embodiment of the invention, the first time a prescription for a specific medication or product is dispensed, the FQHC 100 is charged for a stock package size. Subsequent prescriptions for that medication or product are tracked in the ITS 106 and are applied against the original purchase until the amount dispensed equals or exceeds the stock (or full) package originally charged to the FQHC 100. Once the quantity dispensed exceeds the stock package size, a new purchase event is created, restarting the inventory accumulation process. The retail pharmacy 104 receives replacement product each time a purchase event is recorded to the FQHC 100.

Alternatively, each time a prescription for the healthcare item is received at the retail pharmacy 104, the FQHC 100 is charged for the healthcare item dispensed to the patient. All prescriptions for the medication or product are tracked in the ITS 106. Similar to the situation in which the FQHC 100 is charged for a stock package, the retail pharmacy receives replacement product.

In either case (whether the FQHC 100 is charged for a stock (full) package or for the item dispensed), the retail pharmacy 104 does not need to segregate the inventory because it is replacing the inventory dispensed. All tracking information and accumulation information is maintained within the ITS 106 and is available for weekly or monthly reports. In the event that the relationship between the FQHC 100 and the retail pharmacy 104 is terminated, the retail pharmacy 104 may be responsible for reimbursing the healthcare product distributor 106 for the difference in price between its price and the 340B price for all inventory that is in the process of being accumulated. Such amount due is credited to the applicable FQHC 100 and manufacturers.

In addition to the retail pharmacy 104 receiving a credit or replacement product for the 340B product dispensed, the FQHC 100 receives a charge for the 340B product. If the FQHC 100 is charged for stock (or full) packages, billing may occur each time a stock (or full) package is added to the FQHC's inventory at the ITS 106. Alternatively, the ITS 106 may track items dispensed on behalf of the FQHC 100 by accumulating charges and then bill the FQHC 100 at regular intervals (e.g., weekly or monthly).

In certain instances, a chargeback to the applicable manufacturer is created. As described previously, when a FQHC 100 is charged for a stock (or full) package, subsequent prescriptions for that medication or product are tracked in the ITS 106 and are applied against the original purchase until the amount dispensed equals or exceeds the stock package originally charged to the FQHC 100. Once the quantity dispensed exceeds the stock package size, a new purchase event is created, restarting the inventory accumulation process.

All inventory is trackable and accountable whether a FQHC 100 is charged for a stock package, for each item dispensed, or even for partial packages (e.g., a portion of a stock package). A wide range of inventory reports are available on demand from the system, including usage and accumulation information.

In an example embodiment of the present invention, 340B reconciliation occurs monthly. In this example, the retail pharmacy 104 receives all appropriate inventory billing reports and information for the month. It is also able to track inventory usage on a per NDC number basis or per transaction basis and has the ability to reconcile the usage reports to inventory charges and accumulation. The FQHC 100 receives, if requested, monthly activity reports on a transaction by transaction basis.

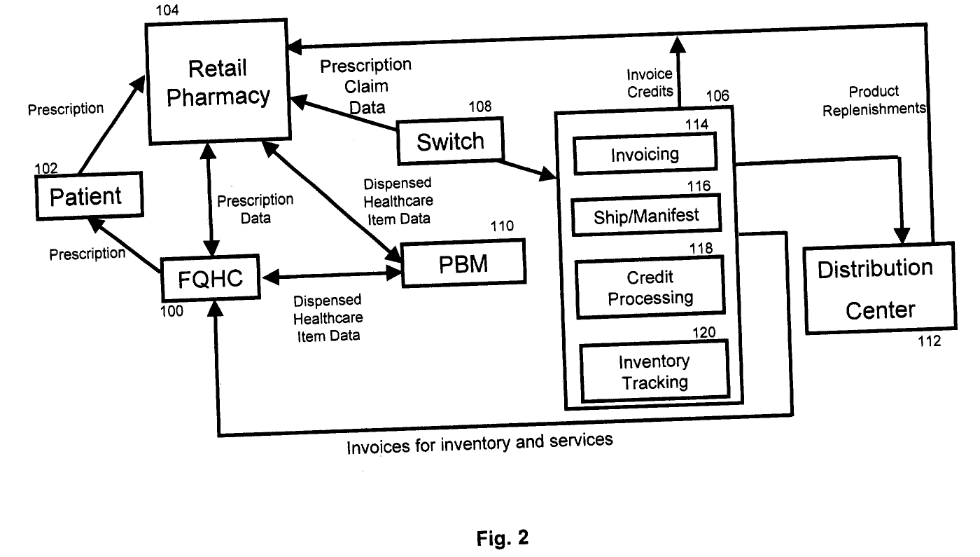

Referring to FIG. 2, a block diagram of the primary components for an example embodiment of the present invention which also depicts details of a healthcare product distributor inventory tracking system is shown. The retail pharmacy 104 receives a prescription from the FQHC directly (e.g., via telephone, fax, or electronically) or from the patient 102 who received the prescription from the FQHC 100. Prescription data is entered in the retail pharmacy computer 104. The patient's eligibility to participate in the 340B program may be determined by a PBM 110 adapted for communication with the FQHC 100 or the retail pharmacy 104. Data regarding the dispensed item is sent to the PBM 110 to determine eligibility. The prescription is adjudicated by the retail pharmacy 104 and prescription claim data is transmitted to a switch 108 that directs the claim information to a healthcare product distributor inventory tracking system (ITS) 106.

The healthcare product distributor ITS 106 may comprise a plurality of processes that operate in conjunction to provide the features and functionality of the present invention. For a retail pharmacy that has a primary vendor agreement with the healthcare product distributor, the ITS 106 operates as follows. As claim data comes in to the ITS 106 from the switch 108, data is captured in inventory tracking module (ITM) 120. ITM 120 creates an inventory record for the item dispensed, the retail pharmacy 104, and the FQHC 100. For the first dispense of the item tracked, the ITM 120 sends a transaction to an invoicing module 114 to generate a charge for a stock package of the item dispensed to the FQHC 100 on its 340B contract or for only the item dispensed to the FQHC 100 on its 340B contract. The ITM 120 then sends a transaction to a credit processing module 118 to issue a credit to the retail pharmacy 104 for a stock package of the item dispensed or for only the item dispensed. The ITM 120 then tracks the appropriate charge and credit quantities within its database for reporting and future dispensing activity. The ITM 120 also generates for the FQHC 100 invoices based on accumulated charges. Invoices may be sent at any time (e.g., weekly, monthly, etc.).

If the retail pharmacy 104 has been credited for a stock package, on subsequent dispenses, the ITM 120 posts the dispense activity to the ITM database and once the accumulated dispense activity surpasses the quantity already charged to the FQHC 100, the ITM 120 generates another charge for the FQHC 106 for a stock package of the dispensed item on its 340B contract. The ITM 120 then generates a credit to the retail pharmacy 104 for the item dispensed. The ITM 120 also generates for the FQHC 100 invoices based on accumulated charges. Invoices may be sent at any time (e.g., weekly, monthly, etc.).

For a retail pharmacy that has a secondary vendor agreement with the healthcare product distributor, the ITS 106 operates as follows. As claim data comes in to the ITS 106 from the switch 108, data is captured in the inventory tracking module (ITM) 120. ITM 120 creates an inventory record for the item dispensed, the retail pharmacy 104, and the FQHC 100. For the first dispense of the item tracked, the ITM 120 sends an order to a ship/manifest module 116 for a stock package of the item dispensed on its 340B contract account or for only the item dispensed on its 340B contract account. The ship/manifest module 116 initiates shipment of the appropriate replacement product to the retail pharmacy 104 and sends a transaction to the invoicing module 114 which then charges the FQHC 100 for the appropriate product on its 340B contract. The ITM then tracks the appropriate charge and ship quantities within its database for reporting and future dispensing activity. The ITM 120 also generates for the FQHC 100 invoices based on accumulated charges. Invoices may be sent at any time (e.g., weekly, monthly, etc.).

For stock packages, on subsequent dispenses, the ITM 120 posts the dispense activity to the ITM database and once the accumulated dispense activity surpasses the quantity already charged to the FQHC 100, the ITM 120 generates another order for the FQHC 100 that is sent to the ship/manifest module 116. The ship/manifest module 116 initiates shipment of the appropriate replacement product to the retail pharmacy 104 and sends a transaction to the invoicing module 114 which then charges the FQHC 100 for the appropriate product on its 340B contract.

The present invention allows FQHCs and retail pharmacies to implement 340B compliant programs by providing a seamless ordering and accounting process. Because it streamlines ordering and receiving, eliminates the necessity of segregated stock, and improves accountability for all parties involved, it results in a simplified system that encourages greater participation of retail pharmacies. Expanded use of the 340B Program by FQHCs will allow more people to benefit from this program and help to improve the health and welfare of the indigent population. Improving access to medication and pharmaceutical care for the indigent will help to reduce overall healthcare costs.

Although the present invention is described in relation to a federal 340B program, any program whether federal, state, local, or private with similar inventory and pricing requirements may benefit from use of the present invention. Various changes or modifications may be made without departing from the scope of the invention defined in the claims and described in the specification.

What is claimed is:

1. A method for distributing a healthcare item comprising:
entering in a pharmacy computer prescription data for a healthcare item for a patient of a healthcare facility;
transferring prescription claim data from said pharmacy computer to a healthcare distributor inventory tracking system;
at said healthcare distributor inventory tracking system:
(i) crediting said pharmacy at a contract price for said healthcare item or providing a replacement of said healthcare item; and
(ii) charging said healthcare facility for said healthcare item.

2. The method of claim 1 wherein said prescription claim data comprises patient information, a date of service, a prescribing clinician, a description of the healthcare item, and a quantity.

3. The method of claim 1 wherein said prescription claim data comprises an account number, a transaction number, a description of the healthcare item, a NDC number, a quantity, and a provider number.

4. The method of claim 1 wherein transferring prescription claim data from said pharmacy computer to a healthcare distributor inventory tracking system comprises transferring prescription claim data from said pharmacy computer to a switch and from said switch to a healthcare distributor inventory tracking system.

5. The method of claim 1 further comprising submitting dispensed healthcare item data derived from the prescription data to a pharmacy benefits manager to determine the eligibility of said patient.

6. The method of claim 1 wherein said healthcare facility is a 340B clinic.

7. The method of claim 1 wherein charging said healthcare facility for said healthcare item comprises charging said healthcare facility for a stock package of said healthcare item.

8. The method of claim 7 further comprising:
(i) charging said healthcare facility for an additional healthcare item;
(ii) crediting said pharmacy at said contract price for said additional healthcare item;
(iii) updating the inventory for said stock package according to said additional healthcare item; and
(iv) repeating steps (i) through (iv) until said stock package is empty.

9. The method of claim 8 further comprising invoicing said healthcare facility based on accumulated charges.

10. The method of claim 1 wherein said dispensed healthcare item includes one or more of the group consisting of pharmaceuticals, medications, medicines, drugs, medical supplies, and surgical supplies.

11. The method of claim 1 further comprising determining patient eligibility according to a protocol between said retail pharmacy and said healthcare facility.

12. An inventory tracking system for managing a healthcare product inventory comprising:
an inventory tracking module for receiving prescription claim data from a pharmacy, said inventory tracking module adapted to create an inventory record for said pharmacy, a prescribing healthcare facility for said prescription claim data, and a dispensed healthcare item according to said prescription claim data;
an invoicing module adapted to generate for said healthcare facility a charge for said dispensed healthcare item;
a credit processing module adapted to issue a credit to said pharmacy for said dispensed healthcare item at a contract price; and
wherein said inventory tracking module processes subsequent dispenses for said dispensed healthcare item by tracking charge and credit quantities.

13. The system of claim 12 wherein said prescription claim data comprises one or more items from the group consisting of an account number, a transaction number, a description of the healthcare item, a date of service, a NDC number, a quantity, and a provider number.

14. The system of claim 12 wherein said inventory tracking module is adapted to receive prescription claim data from a switch.

15. The system of claim 12 further comprising a pharmacy benefits manager for processing said prescription claim data prior to receiving said prescription claim data at said inventory tracking module.

16. The system of claim 12 wherein said healthcare facility is a 340B clinic.

17. The system of claim 12 wherein:
said invoicing module is adapted to generate for said healthcare facility a charge for a stock package of said dispensed healthcare item and to update the inventory for said stock package according to additional prescriptions for said healthcare item; and
said credit processing module is adapted to issue credits to said pharmacy for additional prescriptions for said healthcare item dispensed from said stock package.

18. The system of claim 12 wherein said invoicing module is adapted to invoice said healthcare facility periodically for accumulated charges.

19. The system of claim 12 wherein said dispensed healthcare item includes one or more of the group consisting of pharmaceuticals, medications, medicines, drugs, medical supplies, and surgical supplies.

20. The system of claim 12 wherein said contract price is said pharmacy's actual acquisition cost.

21. An inventory tracking system for managing a healthcare product inventory comprising:
an inventory tracking module for receiving prescription claim data from a pharmacy, said inventory tracking module adapted to create an inventory record for said pharmacy, a prescribing healthcare facility for said prescription claim data, and a dispensed healthcare item according to said prescription claim data;
an ship/manifest module adapted to receive from said inventory tracking module an order for said dispensed healthcare item and to initiate shipment to said pharmacy of a replacement product; and
an invoicing module adapted to generate for said healthcare facility a charge for said dispensed healthcare item.

22. The system of claim 21 wherein said prescription claim data comprises one or more items from the group consisting of an account number, a transaction number, a description of the healthcare item, a date of service, a NDC number, a quantity, and a provider number.

23. The system of claim 21 wherein said inventory tracking module is adapted to receive prescription claim data from a switch.

24. The system of claim 21 further comprising a pharmacy benefits manager for processing said prescription claim data prior to receiving said prescription claim data at said inventory tracking module.

25. The system of claim 21 wherein said healthcare facility is a 340B clinic.

26. The system of claim 21 wherein:
said invoicing module is adapted to generate for said healthcare facility a charge for a stock package of said dispensed healthcare item and to update the inventory for said stock package according to additional prescriptions for said healthcare item; and
said ship/manifest module is adapted to receive from said inventory tracking module additional orders for said dispensed healthcare item from said stock package and to initiate shipments to said pharmacy of replacement products from said stock package.

27. The system of claim 26 wherein said inventory tracking module further processes subsequent dispenses for said dispensed healthcare item after said stock package is depleted by sending to said ship/manifest module an additional order for said dispensed healthcare item and wherein said ship/manifest module initiates shipments to said pharmacy of replacement products from an additional stock package and said invoicing module generates for said healthcare facility charges of said dispensed healthcare item from said additional stock package until accumulated dispense activity for said dispensed healthcare item from said additional stock package surpasses quantities charged to said healthcare facility.

28. The system of claim 21 wherein said invoicing module is adapted to invoice said healthcare facility periodically for accumulated charges.

29. The system of claim 21 wherein said dispensed healthcare item includes one or more of the group consisting of pharmaceuticals, medications, medicines, drugs, medical supplies, and surgical supplies.

30. The system of claim 21 wherein said contract price is said pharmacy's actual acquisition cost.

31. A method for distributing a healthcare item comprising:
entering in a pharmacy computer prescription data for a healthcare item for a patient of a 340B health clinic;
capturing the prescription data at a switch;
sending the prescription data from the switch to a healthcare distributor inventory tracking system;
at said healthcare distributor inventory tracking system:
(i) crediting said pharmacy at a 340B contract price for said healthcare item or providing a replacement of said healthcare item to the pharmacy; and
(ii) charging said 340B health clinic for said healthcare item at the 340B contract price.

32. The method of claim 31, wherein the 340B health clinic is charged for a full package of the healthcare item the first time that a prescription or order is processed for the healthcare item.

33. The method of claim 32, further comprising the step of tracking subsequent prescriptions or orders for said healthcare item and applying the amounts from these prescriptions or orders against the original full package purchase until the amount equals or exceeds the full package originally charged to the 340B health clinic.
